(19) United States
(12) Patent Application Publication
(10) Pub. No.: US 2010/0037966 A1
(43) Pub. Date: Feb. 18, 2010

(54) Method for checking the functionality of an actuator

(76) Inventors: Michaela Braun, Nurnberg (DE); Volker Hirsch, Steinfeld (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/594,399

(22) PCT Filed: Apr. 4, 2008
(86) PCT No.: PCT/EP2008/054079

§ 371 Date: Oct. 2, 2009

(30) Foreign Application Priority Data
Apr. 5, 2007 (DE) 10 2007 016 817.0

(51) Int. Cl. F16K 37/00

(52) U.S. Cl. 137/554; 137/553

(57) ABSTRACT

A method for checking the functionality of an actuator is provided. A control valve is adjusted by an actuating drive by a manipulating element engaging the control valve, a position encoder captures the actual position of the manipulating element, and an electro-pneumatic position controller generates a pneumatic actuating variable as a function of the actual position and a target position. The actuating variable is applied to the actuating drive by an activated magnetic valve that is deactivated to vent the actuating drive. The magnetic valve is briefly deactivated so that it may be tested, such that the manipulating element moves through only a part of its adjustment path. The magnetic valve test is evaluated as successful if the manipulating element has moved at least a prescribed minimum distance.

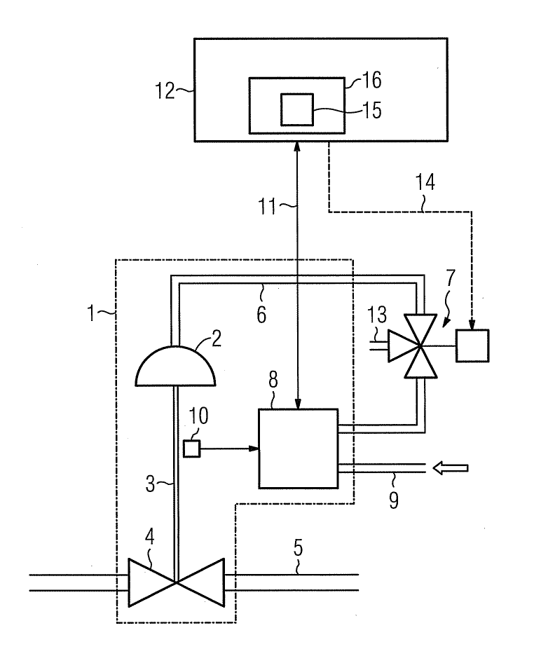

### CROSS REFERENCE TO RELATED APPLICATIONS

This application is the US National Stage of International Application No. PCT/EP2008/054079 filed Apr. 4, 2008, and claims the benefit thereof. The International Application claims the benefits of German Application No. 10 2007 016 817.0 DE filed Apr. 5, 2007, both of the applications are incorporated by reference herein in their entirety.

### FIELD OF INVENTION

The invention relates to a method for checking the functionality of an actuator, in which an actuating valve can be adjusted via an actuating drive by means of an actuating element which acts on the actuating valve, a position transmitter records the actual position of the actuating element, and an electropneumatic position regulator produces a pneumatic manipulated variable as a function of the actual position and a nominal position, which manipulated variable is supplied to the actuating drive via an activated solenoid valve, which can be deactivated in order to vent the actuating drive, wherein, in order to carry out a partial stroke test, the actuating element is briefly moved over a part of its actuating travel, and the actuating movement is recorded during this process, and wherein, in order to test the solenoid valve it is briefly deactivated, as a result of which the actuating element is moved over only a part of its actuating distance.

### BACKGROUND OF INVENTION

A method such as this is known from US 2006/0219299 A1. In the known method, during the testing of the solenoid valve, the pressure difference between the side of the solenoid valve connected to the position regulator and the side connected to the actuating drive is monitored. The solenoid valve test is considered to be successful if, when the solenoid valve is briefly deactivated, the pressure on the side of the actuating drive falls significantly, while the pressure produced by the position regulator remains largely unchanged.

### SUMMARY OF INVENTION

An object of the claimed invention is to allow reliable functional checking of the solenoid valve without any need for special pressure sensors and corresponding pneumatic connections to the position regulator and the solenoid valve, for this purpose.

According to the invention, the object is achieved in that, in the case of the method, the nature of the test of the solenoid valve as stated initially is assessed as successful as a function of the actuating element having moved over a predetermined minimum distance. There is therefore no need for the pressure sensors provided in the known method.

For recording purposes, during the test of the solenoid valve, the position change of the actuating element which takes place during the test is recorded and stored. The tests are preferably carried out automatically by a program procedure outside the actuator in a control device, which deactivates and activates the solenoid valve, communicates with the position regulator and receives the recorded actual positions of the actuating element from this position regulator. The control device in this case automatically presets the times for the tests, and carries out the comparison of the nominal and actual positions.

### BRIEF DESCRIPTION OF THE DRAWINGS

In order to explain the invention further, reference is made in the following text to the single FIGURE of the drawing, which shows one exemplary embodiment of an actuator for carrying out the method according to the invention.

### DETAILED DESCRIPTION OF INVENTION

The actuator 1 contains a pneumatic actuating drive 2, which operates a valve 4 via an actuating element 3, in this case in the form of a push rod, and in the process controls the fluid flow in a pipeline 5. The actuating drive 2 is connected via a pneumatic line 6, with a solenoid valve 7 arranged therein, to a position regulator 8 which is supplied with compressed air from a supply line 9. A position transmitter 10 records the actual position of the actuating element 3, and supplies this to the position regulator 8, which sets a variable pressure in the line 6 as a function of the actual position and a predeterminable nominal position as a manipulated variable, in order to move the actuating element 3 with the valve 4 to the nominal position. In order to allow the nominal position to be preset from the outside and the actual position of the actuating element 3 to be checked, the position regulator 8 is connected via a communication line 11 to a control device 12.

The solenoid valve 7 is in the form of a three-way valve and, in the activated state, connects the position regulator 8 to the actuating drive 2. In the deactivated state, the actuating drive 2 is disconnected from the position regulator 8 and, instead of this, provides venting via a solenoid valve outlet 13, as a result of which the actuating drive 2 is unpressurized, and the actuating element 3 with the valve 4 are moved to a safe position, for example under the influence of a spring in the actuating drive 2. During normal operation, the solenoid valve 8 is activated, and it is deactivated only in an emergency. The solenoid valve 7 is activated and deactivated directly by the control device 12 via a control line 14.

During a partial stroke test, which is initiated automatically at regular time intervals by the control device 12, the valve 4 is briefly moved, with the solenoid valve 7 activated, from the respective current position over a part of its actuating travel, and is then moved back again. The position change is in this case sufficiently small that this does not disturb, or disturbs only insignificantly, the continuous operation of the installation in which the valve 4 is installed. During each test, the actual position reached by the actuating element 3 and valve 4 is stored and recorded in a memory 15 in the device 12. The partial stroke test is assessed as successful as a function of whether a predetermined position change is achieved within a minimum time, or whether the position change reaches a minimum value within a predetermined time. In this way, it is possible to find out when the actuating valve 4 is blocked or reacts too slowly. The position changes stored during successive partial stroke tests can be compared with one another in an evaluation device 16 in the device 12 and can be analyzed for changes which represent a trend in order, for example, to determine the maintenance requirement.

After every or each n-th partial stroke test, the functionality of the solenoid valve 7 is tested by briefly deactivating the solenoid valve 7. The solenoid valve 7 can be deactivated by a deactivation pulse of predetermined time duration, or by a limited deactivation pulse sequence. The deactivation time duration is chosen such that the actuating element 3 is moved only over a small part of its actuating travel from the respective current position, and is then moved back again. During this test as well, the actual position reached by the actuating element 3 and/or the valve 4 is stored and recorded in the memory 15 in the device 12. The test is assessed as being successful when the actuating element 3 has moved through a predetermined minimum distance. The position changes stored during successive tests of the solenoid valve 7 are compared with one another in an evaluation device 16 in the device 12 and are analyzed for changes which represent a trend in order, for example, to determine the maintenance requirement.

1.-3. (canceled)

4. A method for checking the functionality of an actuator, comprising:
providing an actuating valve adjustable via an actuating drive by an actuating element which acts on the actuating valve;
recording an actual position of the actuating element by a position transmitter;
producing a pneumatic manipulated variable as a function of the actual position and a nominal position by an electropneumatic position regulator;
supplying the manipulated variable to the actuating drive via an activated solenoid valve, wherein the solenoid valve is deactivated in order to vent the actuating drive;
moving briefly the actuating element over a part of its actuating travel in order to carry out a partial stroke test;
recording the actuating movement of the actuating element; and
deactivating briefly the solenoid vale in order to test the solenoid valve such that the actuating element being moved over only a part of its actuating travel,
wherein the test of the solenoid valve is assessed as successful as a function of the actuating element having moved over a predetermined minimum distance.

5. The method as claimed in claim 4, further comprising:
recording and storing a position change of the actuating element taking place during the test of the solenoid valve.

6. The method as claimed in claim 5, further comprising:
providing a control device, the test being carried out by a program procedure outside the actuator in the control device,
wherein the control device deactivates and activates the solenoid valve, communicates with the position regulator and receives the recorded actual positions of the actuating element from this position regulator.
